(19) United States
(12) Patent Application Publication
(10) Pub. No.: US 2002/0116319 A1
(43) Pub. Date: Aug. 22, 2002

(54) Sports related electronic bidding methods

(76) Inventor: John Black, Las Vegas, NV (US)

Correspondence Address: Kirton & McConkie, 1800 Eagle Gate Tower, 60 East South Temple, Salt Lake City, UT, 84111, US

(21) Appl. No.: 09/951,122

(22) Filed: Sep. 13, 2001

Related U.S. Application Data
(60) Provisional application No. 60/260,307, filed on Jan. 8, 2001.
(60) Provisional application No. 60/232,746, filed on Sep. 15, 2000.

(51) Int. Cl. G06F 17/60

(52) U.S. Cl. 705/37

(57) ABSTRACT

The present invention incorporates various bidding methods to facilitate the organization, coordination, and promotion of competitive sporting events on a wide area network such as the Internet, interactive networks, and other communication means. The present invention also incorporates the system and method of gathering, processing, and searching information described in application Ser. No. 60/195,025 filed Apr. 6, 2000.

This application claims priority to U.S. Provisional Application Serial No. 60/260,307 filed Jan. 8, 2001, and to U.S. Provisional Patent Application Serial No. 60/232,746 filed Sep. 15, 2000, both incorporated herein by reference.

### BACKGROUND

1. Field of the Invention

The invention relates to electronic commerce. Specifically, the invention relates to using various bidding methods to facilitate the organization, coordination, and promotion of competitive sporting events on a wide area network such as the Internet, interactive networks, and other communication means.

2. Background

Sports are one of America's favorite pastimes. In addition to being a popular leisure activity, sports and sporting events have become big business. Unfortunately, many sports have been marred by allegations of corruption. These allegations are widespread and have harmed the reputations of many athletes, agents, promoters and many others in many sports. One of the sports in which improprieties are often alleged is boxing. Some people allege that professional boxing rankings are corrupt and that phony mandatory challengers have led to rigged promotions, purse bids, and an unfair competition system. Promoters have been at the center of this controversy as they have allegedly leaked false stories to the media in order to get more and better offers from venues. Managers of fighters have also engaged in similar improprieties in promoting their fighters.

Engaging in these types of deceitful activities has hurt the credibility of the boxing industry and of other sporting industries that engage in similar practices.

### SUMMARY AND OBJECTS OF THE INVENTION

The present invention incorporates various bidding methods to facilitate the organization, coordination, and promotion of competitive sporting events on a wide area network such as the Internet, interactive networks, and other communication means. The present invention also incorporates the system and method of gathering, processing, and searching information described in application Ser. No. 60/195,025 filed Apr. 6, 2000 (hereafter referred to as application Ser. No. 60/195,025).

One embodiment of the invention deals with made fights. Made fights are matches where two fighters agree to fight each other. Normally, the two fighters have also agreed on the purse. The purse is the prize money given to the fighters. In this embodiment, a promoter puts together a fight and then auctions the fight to the highest bidder. This embodiment may include an auction between a promoter and a venue, a promoter and an advertiser, or between the promoter and anyone he or she chooses to solicit. The two fighters may also bid their made fight to a promoter, venue or advertiser. This embodiment provides fighters with a worldwide market and will likely lead to more offers from venues and promoters.

Another embodiment of the invention deals with purse bids. In one version of the purse bid embodiment, one fighter challenges another to a fight. The challenger tries to entice the challengee to accept the offer by offering an attractive purse. Before accepting the challenge, the challengee may put the challenge up for bid. The winning bidder would then have a made fight and could then transfer the fight to the made fight embodiment of the invention to get bids from venues and promoters.

In another version of the purse bid embodiment, a promoter or venue may try to entice two fighters to fight each other by offering an attractive purse. For example, if the bidding party is a promoter, he or she bids for the right to promote the fight. If the bidding party is a venue, the party representing the venue bids for the right to host the fight.

One embodiment of the present invention creates new bidding models for competition with internal controls and independent audits designed to insulate the process from manipulation by those with financial interests. The system of the present invention is founded on free agency, market forces, and honest arms-length deals. Promoters and other buyers of boxing entertainment will be able to bid a number of ways, including a reverse auction type bid where they can specify the fights they want by weight class, number of rounds, etc., and boxers meeting that criteria can compete to offer the best price. Promoters can sort these offers in a variety of ways for evaluation.

Even world champions, ranked fighters and their management could benefit from an online marketplace where they can receive more offers from venues and promoters worldwide that would like to bid on their fights. One embodiment of the present invention provides an “auction house” for fights. A promoter who submits a purse bid must promote the bout within the terms of the offer as defined and agreed upon by the fighters management. For example, a well known fighter has ten possible opponents that have the marquee value which will contribute significantly to the pay-per-view buys or television ratings and the live gate. There are hundreds of promoters and venues in scores of countries that could bid on a fight featuring this famous fighter. Each bid would vary depending on the proposed opponent. Some venues might wish to make a lucrative bid to feature the famous boxer fighting practically any other fighter. Other venues would be more discretionary in their bidding. At a website operating in accordance with the present invention fighters and their management will be able to sort the many bids in a variety of ways. The website could be called, for example, PurseBid.com.

Under the present “prior art” system, promoters first “lock up” a fight under a promotion contract or option with one fighter and an option with a prospective opponent. They then shop the fight around. They frequently use the media to “leak” false stories about negotiations or venue offers which are on the table. This strategy works to get more and better offers from venues in play. Managers of fighters attempt to do the same when they shop their champion to promoters. This, too, is nothing more than a deceptive auction process with the bidders not knowing the validity of the other offers. Promoters also try to use long-term promotion contracts with various options in an attempt to eliminate or reduce a manager's future negotiating leverage.

PurseBid.com could make available to famous fighters and other “marquee” fighters an online matchmaking service which will get them offers for the various fights listed on their own Webpage on the website (i.e. Page of Challenges) from all the promoters and stadiums and venues in the world, in effect, a promoter/venue-fight matchmaking service. It could be called the Promoter/Venue Bidder's Page where each venue or promoter can bid and compete for hosting a big event, such as a Mike Tyson fight.

Fighters could also have a Television Bidder's Page of offers to televise their fights. Another Webpage (e.g. GreatFightsOnline.com) will collaborate with the bidders desiring to televise a fight. Like promoters, television companies sometimes use the contract terms to try to reduce or eliminate a manager's or promoter's future negotiating leverage. Similar to the venues, PurseBid.com will present to the television companies each of the challengers so they can see the other party's bids and determine which fights they want to bid on and what they are willing to pay.

In prior art systems, the promoters can unduly influence or manipulate the process using media leaks, false and misleading statements about what others are willing to pay, and by offering only a limited number of venues and/or television dates with which to work. The present invention will offer a broad market under an open bidding auction process and make all the relevant information available to the fighter, so he or she does not have to depend on the integrity of his or her manager or promoter. A website such as PurseBid.com will add significant value to everyone concerned with marquee fighters and let each venue and television company know what the others are bidding for fights. They will be able to challenge and increase their bid just like an auction. Online offers and contracts will be valid with new software and Federal legislation concerning electronic contracts.

Additionally there may be a fighter's matchmaking page for advertisers and sponsors that provides a means for bidding on advertising commercials and signage. Various types of advertising and sponsorship may be put up for bid. Advertising with commercials between rounds can be tailored on the Internet to each country and local advertisers can bid on these advertising rights for marquee fights. By increasing the number of parties bidding for television and other advertising for marquee fighters will increase indirect revenue. It will also reduce or eliminate the negotiating disadvantages of the prior art systems and establish greater market values. This auction process also reduces or eliminates the creditability [credibility]? issue of competing offers. With the advertiser's page at PurseBid.com, more sponsors and advertisers around the world are able to do business and can be considered as a potential source of revenue.

Sponsors may also bid for signage, the rights to have their names prominently displayed on a banner behind the ring and on the ring mat and comer pads. Signage has great publicity value. The universe and the value of the fights of all marquee fighters are greatly expanded through PurseBid.com's auction format for fights, venues, television, sponsors and advertisers.

Other embodiments of the invention show its broad appeal to a variety of sports. For instance, in one embodiment, golf promoters bid to entice certain golfers to participate in tournaments. This embodiment may work especially well with Skins games, where a few golfers participate in a tournament that awards money based on a golfers performance each hole, rather than on his or her entire round. A golf promoter may send out a bid to a golfer with details of the award money and any other benefits the golfer may receive from participating in the tournament.

Another embodiment of the invention applies to tennis. For instance, two tennis players may decide they want to play in an exhibition match for money. The two tennis players can auction their match over the Internet to various promoters or venues.

The present invention is not limited to the sports or competitions in the examples given. Any competitor may benefit from the invention. A competitor may induce bids from various agents in making his or decision on which agent to accept. This would give the athlete more leverage in obtaining an agent.

Any embodiment of this invention may include various transaction fees. Such transaction fees may be charged to any of the parties during the bidding process.

This invention offers more open and complete disclosure than the prior at. For instance, fighters can more easily compare bids between promoters, venues, or advertisers during the bidding process. In the case of a purse bid, once accepted, the bidding party is bound to the terms of the agreement.

### BRIEF DESCRIPTION OF THE DRAWINGS

These and other features and advantages of the invention will now be descried with reference to the drawing of certain preferred embodiments, which are intended to illustrate and not to limit the invention, and in which:

FIG. 1 is a high-level architectural drawing illustrating the primary components of a system that operates in accordance within the present invention.

FIG. 2 is a mid-level architectural drawing illustrating the structure and setup of numerous databases within the present invention.

FIG. 3 is a flow diagram illustrating a transaction sequence related to promoting in accordance with an embodiment of the present invention.

FIG. 4 is a flow diagram illustrating a transaction sequence related to venue owners in accordance with another embodiment of the present invention.

FIG. 5 is a flow diagram illustrating a transaction sequence related to sponsors in accordance with a further embodiment of the present invention.

FIG. 6 is a flow diagram illustrating a transaction sequence related to fighters in accordance with an embodiment of the present invention.

FIG. 7 is a flow diagram illustrating a transaction sequence related to tennis players in accordance with an embodiment of the present invention.

FIG. 8 is a flow diagram illustrating a transaction sequence related to golf promoters in accordance with an embodiment of the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

Embodiments of the present invention may be used in many different sporting industries. Described herein are embodiments of the present invention as applied to boxing, golf and tennis. While embodiments of the present invention may be used in many applications, applications to the boxing, golf and tennis industries are thought to be illustrative of many of these embodiments and are used herein as non-limiting examples of these embodiments. Relative to these three industries, the users of the present invention may include, without limitation, boxers, golfers, tennis players, promoters, agents, managers, trainers, fans, hotel-casino properties, television producers and broadcasters, arenas, venues, matchmakers, booking agents, consumers, and many others who coordinate, arrange, and are involved in related sporting events.

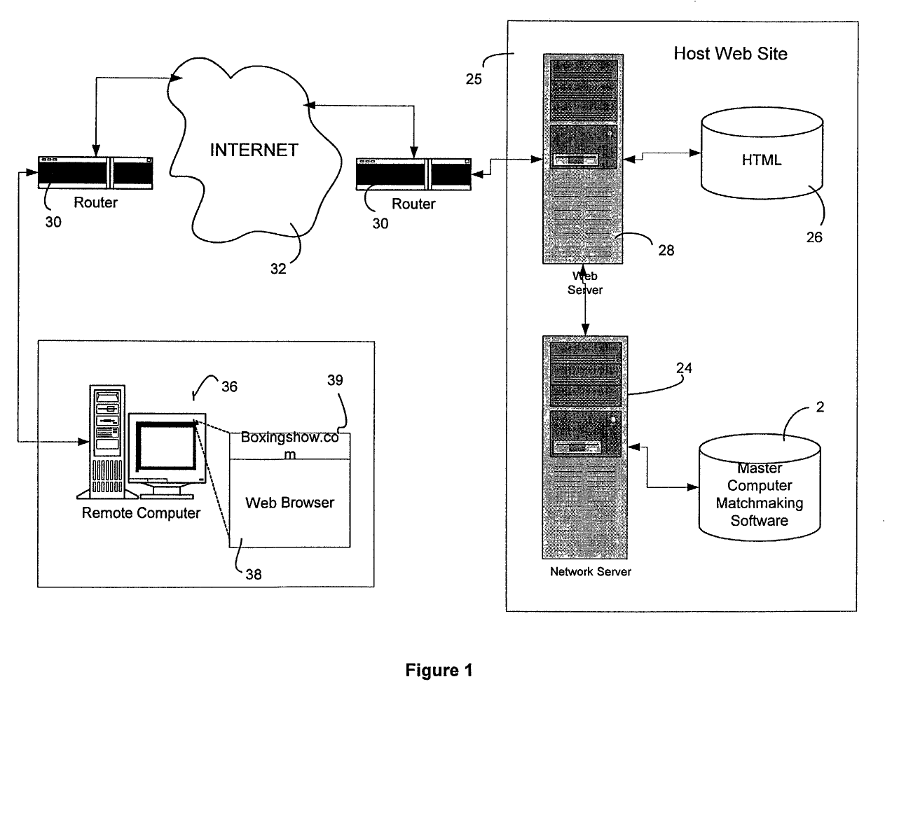

FIG. 1 is an identical reproduction of FIG. 1 from application Ser. No. 60/195,025 filed Apr. 6, 2000 (hereafter referred to as application Ser. No. 60/195,025). It is included in this application to show the relatedness of both applications and to give adequate background and support for the present invention.

In reference to FIG. 1, one embodiment of both the present invention and the invention referred to in application Ser. No. 60/195,025, comprises the general architecture of a matchmaking system. The system includes a remote computer 36, a Web site 25, all linked together via the Internet 32. Remote computer 36 may be any type of computing device that supports use of interactively browsing data via Web browser 38 that is capable of receiving and transmitting HTML 26. HTML 26 documents are the preferred method of providing a graphical user interface to access the systems and methods embodied in both inventions. Use of HTML 26 as a graphical user interface yields great flexibility to the invention because HTML 26 transmitted to Web browser 38 is easily changed and modified to provide the greatest benefit to the user. Remote computer 36 may be a personal computer running a Microsoft Windows 98 or NT operating system. Web browser 38 may be any commonly known browser software such as Microsoft Internet Explorer or Netscape Navigator used in decoding HTML 26. It is preferred that Web browser 38 include some form of encryption data transfer system to ensure confidentiality and prevent interception of communication and electronic commerce data as it is transferred across Internet 32.

Web site 25 is a site that provides various functionality for allowing those in the boxing industry to gather information, coordinate boxing matches, and permit individuals to purchase goods and services. It is preferred that Web site 25 could function in the manner described below, but could also be setup and function in any configuration that would allow the transmittal of data across a network to remote computer 36. Web site 25 will encompass Web server 28 capable of storing and accessing documents in HTML 26. Web server 28 may be connected to a network server 24. Network server 24 provides the primary means of running the master computer matchmaking software 2. Matchmaking software 2 will be described in greater detail below. Typically, Web site 25 will be operated and maintained by a business entity responsible for keeping the data updated, providing the goods and services purchased by individuals, and for handling customer service issues. In the example described herein, Web site 25 is the site of Boxingshow.com 39.

In operation, a user accesses Web site 25 using standard Web browser 38. A network protocol such as TCP/IP is sent from remote computer 36 to router 30 across Internet 32 to Web server 28. Web server requests information from matchmaking software 2 residing on network server 24. Matchmaking software 2 processes request from Web server 28 and transmits request to Web server 28. Web sever 28 converts the information to HTML 26 and sends a TCP/IP response to router 30 across Internet 32 to remote computer 36. Web browser 38 decodes HTML 26 message and displays the information in Web browser 38 to the user. Web site 25 can comprise any method, which provides the function of embodiments of the present invention and considered within the scope of embodiments of the present invention.

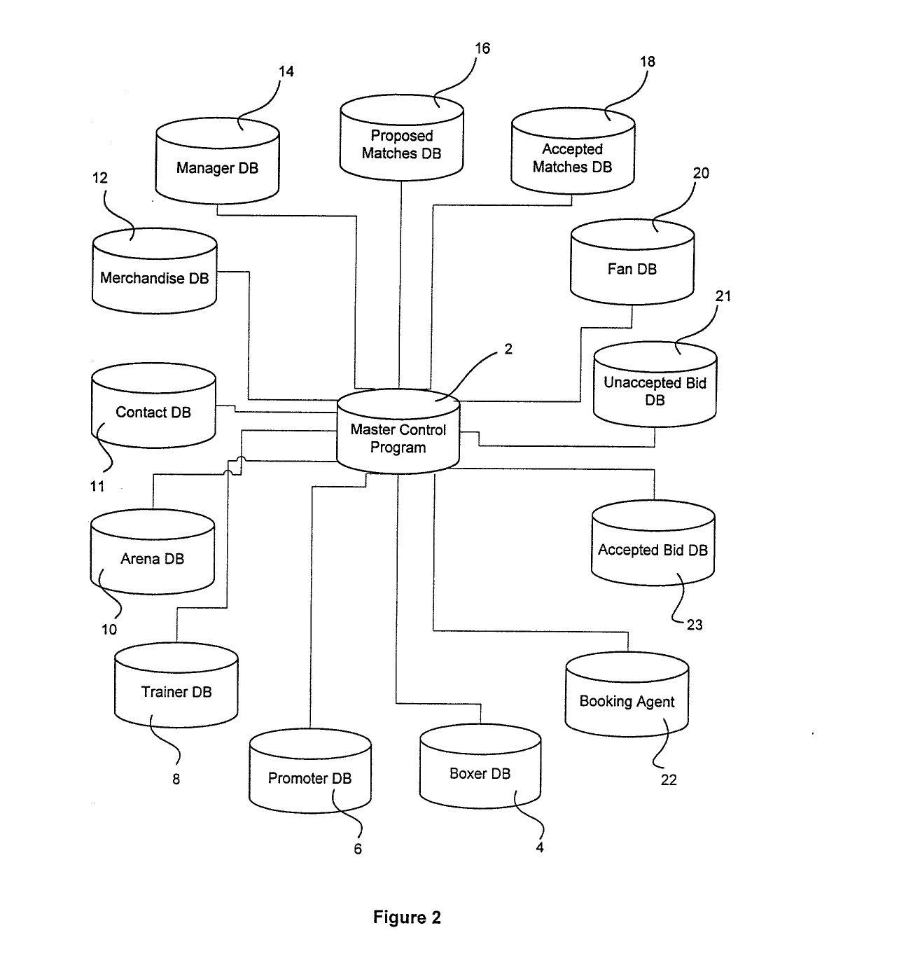

As further illustrated in FIG. 2 the structure of the present invention contains an arena database 10. Arena database 10 stores information relevant to boxing arenas throughout the world. As part of boxing promoter's and manager's jobs, they are required to find an arena or facility where the boxing match can take place. Therefore, arena database 10 produces a location for the storage of information on boxing arenas. Without limitation, examples of data that can be stored in arena database 10 are calendar of scheduled events, arena seating capacity, size, location, contact information, list of previous boxing events held, price range of tickets sold, and photographs of the arena. As with the other databases previously described, certain information within the database will have controlled access. Other aspects relating to arena database 10 will become known through use of the invention.

FIG. 2 also shows an embodiment for a contact database 11. Contact database 11 stores information that will be used by the present invention in various notification procedures. FIG. 9 shows in greater detail the functionality of contact database 11. Contact database 11 will hold information about boxers, managers, trainers, arenas, promoters and any other individuals which use the system. Users are referred to as the primary contact 120. Information stored in contact database 11 about primary contacts 120 could consist of name, address, e-mail address, phone numbers, fax number and pager numbers. Primary contacts 120 are given the ability to set a preferred notification method 122. Notification method 122 for primary contact 120 is stored in contact database 11. Notification method 122 could consist of pager, e-mail, phone or cell phone, and fax machine. Contact database 11 also stores the rules for notification 124 of primary contacts 120. Rules of notification 124 could encompass a specified time of day in which the user is to be notified. Additionally, for example, rules of notification 120 could specify that a user is to be notified by e-mail before 12:00 pm and by pager after 12:00 pm.

Referring again to FIG. 2, selected embodiments of the present invention also comprise a manager database 14. Manager database 14 is very similar in structure to trainer database 8 and promoter database 6 as previously described. Manager database 14 is designed to hold information necessary assist a boxer in finding a manager. Manager database 14 can hold, but is not limited to, biographical data such as age, years of experience, location, address, telephone, e-mail address, and photographs. Moreover, statistical data such as past fighters managed, current boxers they are managing, successfulness of past fighters, connections to industry professionals, and video clips which can be held in manager database 14. As with other databases, manager database 14 stores log-in information of managers useful in controlling their access to certain areas of specific database information. Manager database 14 also contains similar security rules to the other databases already described, restricting access to information stored within.

In other embodiments of the present invention boxers are capable of challenging or accepting a challenge of another boxer to a fight. Therefore, it becomes necessary to store the boxer's challenges somewhere within the system. Consistent with the previously described structure, the present invention incorporates a proposed match database 16. Proposed match database 16 stores any information relating to a boxing match which has be proposed by one boxer, but not yet accepted by the second boxer. Other information which could be stored in proposed match database 16 are the conditions which the challenging boxer has placed upon the match. For example, he may wish to fight a particular boxer, but only if the winning purse is a certain amount of money. He may wish to fight a boxer who falls within a certain weight class or who will fight on a certain date. The present invention provides a method where the boxer can require conditions to be met before he is willing to fight. All of this data is stored in proposed match database 16. Data stored within proposed match database 16 will have controlled access. For example, only boxers, managers, and promoter will have access to view and manipulate the data. Proposed match database, like all other databases in the system, security rules are incorporated to control access. It is possible that the system can be modified to allow any desired user to view and change the data within proposed match database 16. These circumstances are controlled by the manager of Web site 25 and can be evaluated and changed as desired and can be further explored through use of the invention.

A further embodiment of the present invention is an accepted match database 18. Accepted match database 18 is very similar in function and structure to proposed match database 16. Once a boxer has accepted a challenge from another boxer, and the specific terms are agreed upon, data is transferred from proposed match database 16 to accepted match database 18. Although the data contained in the database is similar, it is used for different purposes. Data stored in accepted match database 18 is most useful to promoters. Promoters will find data in accepted match database 18 extremely helpful to find pre-made boxing matches. The invention gives promoters the ability to efficiently search data in accepted matches database 18 and find boxing matches that they want to promote. Therefore, accepted match database 18 has the ability to store all of the information which was once contained in proposed match database 16, but can be used for different purposes. Accepted match database 18 has the same security rules as proposed match database 16 and allows only limited access.

FIG. 2 also shows an unaccepted bid database 21 and an accepted bid database 23. The unaccepted bid database 21 contains all unaccepted bids related to a particular item, right, or event being auctioned. For instance, in this embodiment, a boxer may find all bids from promoters wanting to represent him or her in an upcoming fight. In a related embodiment, a tennis player may collect bids from clothing companies, who are bidding to endorse the player. Once a bid is accepted, the unaccepted bid database 21 sends the accepted bid to the accepted bid database 23.

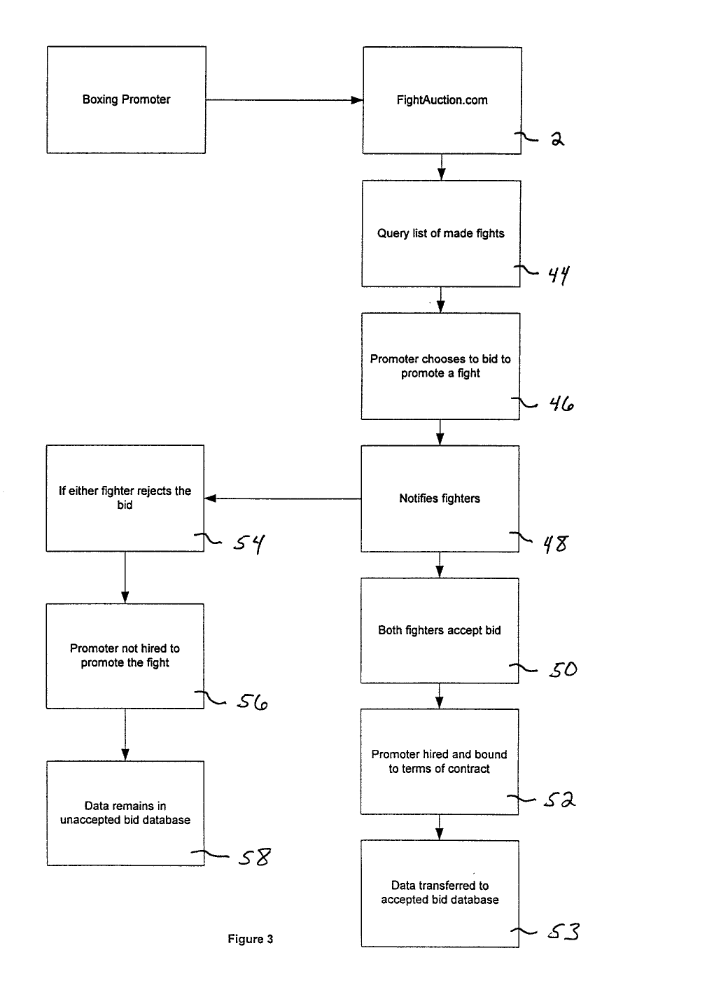

FIG. 3 shows the process of only one of the many embodiments of the present invention. In this embodiment, a boxing promoter 40 logs on to a FightAuction.com 42. The boxing promoter 40, queries a list of made fights 44. If the boxing promoter 40 chooses to bid to promote a fight 46, boxing promoter 40 notifies the fighters 48 of his or her bid. If both fighters accept the bid 50, the promoter 40 is hired and is bound to the terms of the contract 52. The data is then transferred into the accepted bid database 53. If either fighter rejects the bid 54, the promoter is not hired to promote the fight 56 and the data remains in the unaccepted bid database 58.

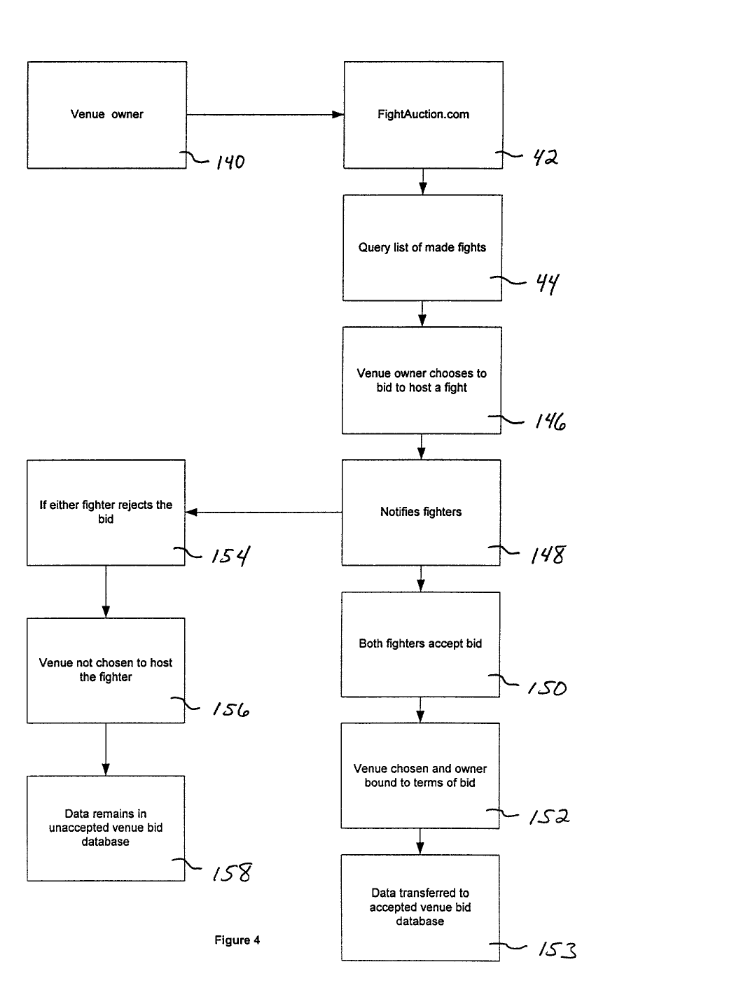

FIG. 4 is similar to FIG. 3 and shows the process of one of many embodiments of the present invention. In this embodiment, as in FIG. 4, an individual logs on to a website such as fightauction.com 42. In this embodiment, in addition to having software that allows a boxing promoter 40 to place a bid to promote a fight, fightauction.com 42 also provides software that allows other parties to place bids on services and contracts related to a particular fight. FIG. 4 shows a venue owner 140 that logs onto fightauction.com 42. The venue owner 140 queries a list of made fights 44. If the venue owner 140 chooses to bid to host a fight 146, the venue owner 140 notifies the fighters 148 of his or her bid. If both fighters accept the bid 150, the venue owner 140 is chosen to host the fight and is bound to the terms of his or her bid 152. Information is then transferred into the accepted venue bid database 153. If either fighter rejects the bid 154, the venue is not selected to host the fight 156 and the data remains in or is transferred to an unaccepted bid database 158.

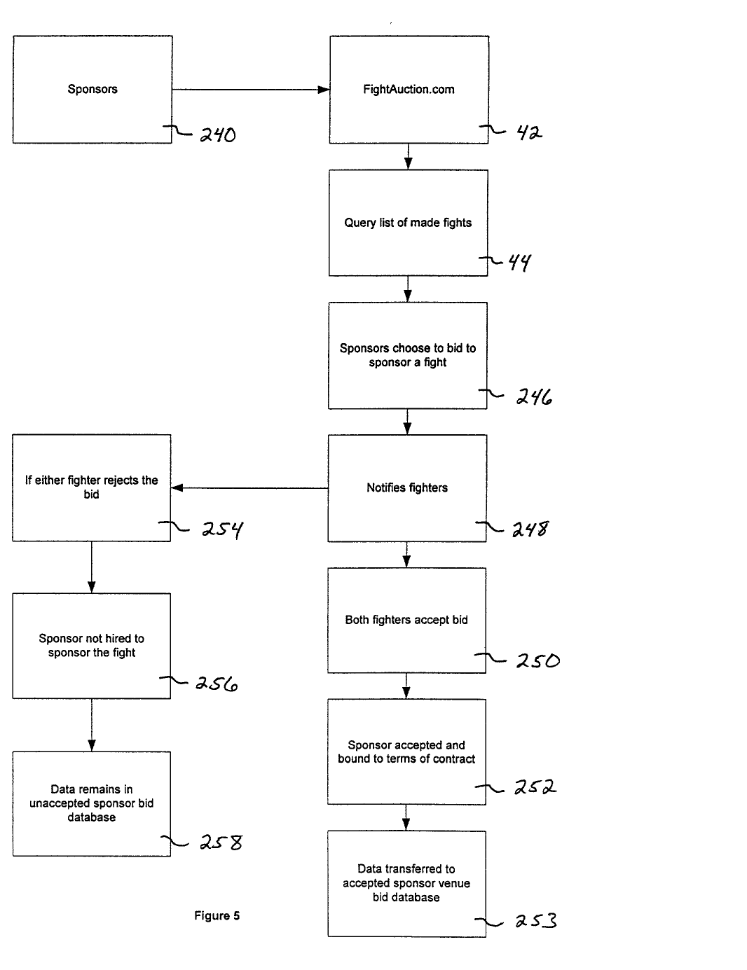

FIG. 5, like FIGS. 3 and 4, shows a flowchart of the process by which a sponsor 240 is able to bid on sponsoring a made fight. Sponsor 240 logs onto fightauction.com 42. The sponsor 240 queries a list of made fights 44. If the sponsor 240 chooses to sponsor a fight 246, the sponsor 240 notifies the fighters 248 of his or her bid. If both fighters accept the bid 250, the sponsor 240 is hired to sponsor the fight according to the terms of his or her bid 252. The data is then transferred into the accepted sponsor bid database 253. If either fighter rejects the bid 254, the sponsor is not hired to sponsor the fight 256 and the data remains in or is transferred to the unaccepted sponsor bid database 258.

The present invention is especially advantageous to Marquee fighters. Allowing Marquee fighters to accept bids related to their fights from challengers, promoters, venues, sponsors, and others creates a more open market for the organization and presentation f a boxing match with a Marquee fighter. A more open market should in turn provide for a better and more lucrative sporting event.

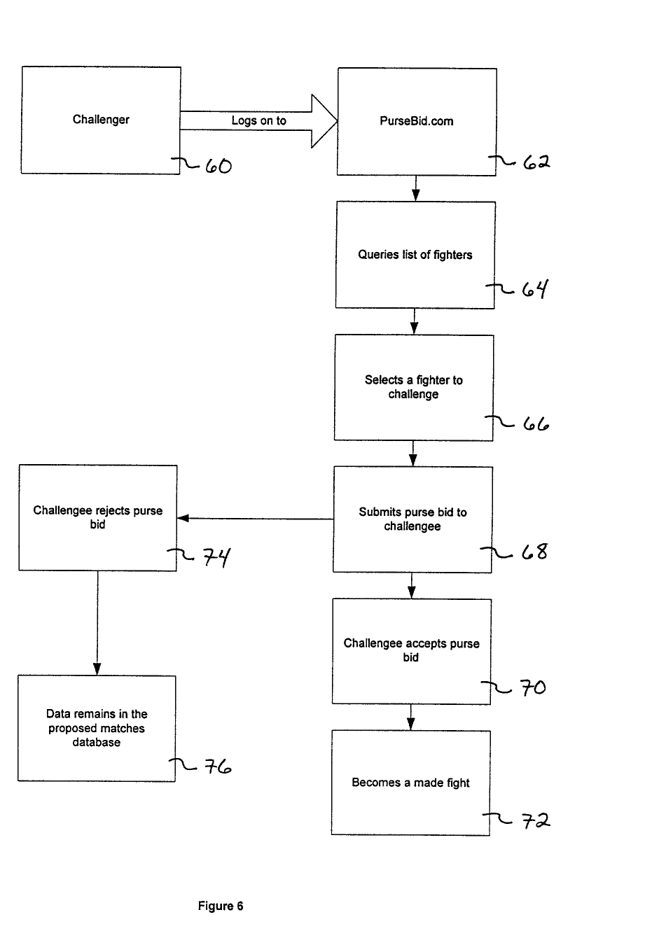

In FIG. 6, a challenger logs on 60 to PurseBid.com 62. The challenger 60 queries a list of fighters 64 and selects a fighter to challenge 66. The challenger 60 then submits a purse bid to challengee 68 along with his or her challenge. The purse bid will typically be a percentage of the entire purse. If the challengee accepts the purse bid 70, the fight becomes a made fight 72. If the challengee rejects the purse bid 74, the data remains in the proposed matches database 76.

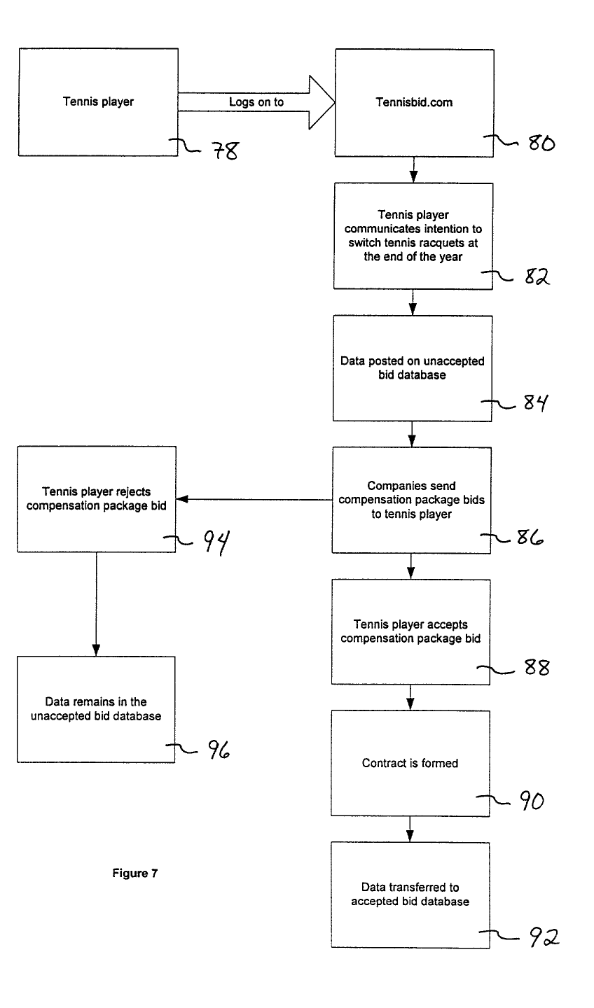

FIG. 7 depicts an embodiment of the present invention that deals with tennis. In this embodiment, a tennis player logs on 78 to tennisbid.com 80. The tennis player communicates his or her intention to switch tennis racquets at the end of the year 82. This data is posted on the unaccepted bid database 84. Tennis racquet-manufacturing companies then submit compensation package bids to the tennis player for him or her to consider 86. If the tennis player accepts the compensation package bid 88, a contract is formed 90. The data is then transferred to the accepted bid database 92. If the tennis player rejects the compensation package bid 94, the data remains in the unaccepted bid database 96.

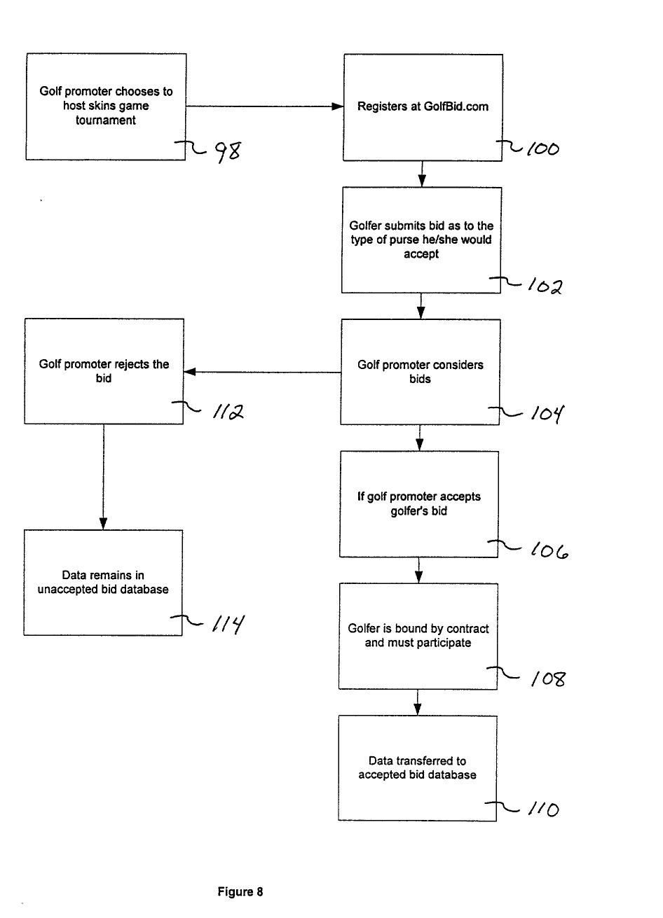

FIG. 8 depicts an embodiment of the present invention that deals with golf. In this embodiment, a golf promoter decides to host a Skins game tournament 98 and registers at GolfBid.com 100. A golfer then submits a bid as to how much money he or she would demand if he or she chooses to participate 102. After a certain period of time, the golf promoter decides which bids he or she will accept 104. If the golf promoter accepts a bid 106, the golfer is bound by contract to participate in the Skins game tournament 108. The data is then transferred to the accepted bid database 110. If the golf promoter rejects the bid 112, the data remains in the unaccepted bid database 114.

The present invention is not limited to use with the examples of competitive events listed above. Other types of competitive events include Adventure Racing, Airsoft, Archery, Auto Racing, Badminton, Baseball, Basketball, Biathlon, Billiards, Board Sports, Boat Racing, Bobsledding, Bowling, Boxing, Bullfighting, Camel Racing, Canoe Polo, Canoe-Kayak Racing, Cheerleading, Cockfighting, Cricket, Croquet, Curling, Cycling, Danball, Dog Racing, Dogsledding, Equestrian Events, Extreme Sports, Fencing, Fishing, Flying Discs, Footbag/Hacky Sack, Football, Golf, Gymnastics, Handball, Hockey, Horse Racing, Hurling, Jai-Alai, Kabaddi, Kickball, Korfball, Lacrosse, Luge, Lumbering, Martial Arts, Motorcycle Racing, Mountainboarding, Netball, Orienteering, Paddleball, Paddling, Paintball, Pickleball, Polo, Racewalking, Racquetball, Ringette, Rodeo, Rounders, Rowing, Rugby, Running, Sailing, Sandboarding, Sepak Takraw, Shinty, Shooting, Skateboarding, Skating, Skeleton, Skiing, Skydiving, Snowboarding, Snowmobiling, Soccer, Softball, Squash, Surfing, Swimming and Diving, Table Tennis, Tchoukball, Tennis, Track and Field, Triathlon, Tug-of-War, Twirling, Volleyball, Wakeboarding, Walking, Water Polo, Waterskiing, Weightlifting, Windsurfing, Winter Sports, and Wrestling.

The present invention could be used in other competitive events unrelated to athletic, such as competitive games, performing arts, and any other type of competitive event.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A bidding method for organizing and coordinating a competitive event comprising the steps of:
receiving information from at least one user regarding said user's willingness to consider participation in a potential competitive event;
a) organizing said information received from said at least one user into an electronically searchable format;
b) providing access to said information organized into an electronically searchable format to said user and third parties; and
c) bidding related to participation in said potential competitive event.

2. The bidding method of claim 1, wherein the bidding related to participation in the potential competitive event is bidding related to promoting the potential competitive event.

3. The bidding method of claim 1, wherein the bidding related to participation in the potential competitive event is bidding related to hosting said potential competitive event.

4. The bidding method of claim 1, wherein the bidding related to participation in the potential competitive event is bidding related to competing in said potential competitive event.

5. The bidding method of claim 1, wherein the bidding related to participation in the potential competitive event is bidding related to advertising said potential competitive event.

6. The bidding method of claim 1, wherein the bidding related to participation in the potential competitive event is bidding related to sponsorship of said potential competitive event.

7. The bidding method of claim 1, wherein information concerning the bid of a first bidding party is made available to other bidding parties.

8. The bidding method of claim 1, wherein information concerning the bid of a first bidding party is not made available to other bidding parties.

9. The bidding method of claim 1, wherein bidding is performed electronically over a global computer network.

10. A computer apparatus which facilitates a bidding method for organizing and coordinating a sporting event comprising:
a) means for receiving information from at least one user regarding said user's willingness to consider participation in a potential competitive sporting event;
b) means for organizing said information received from said at least one user into an electronically searchable format;
c) means for providing access to said information organized into an electronically searchable format to said at least one user and third parties; and
d) means for electronic bidding related to participation in a potential sporting event.

11. The computer apparatus of claim 10, wherein the bidding related to participation in the potential sporting event is bidding related to promoting the potential sporting event.

12. The computer apparatus of claim 10, wherein the bidding related to participation in the potential sporting event is bidding related to hosting said potential sporting event.

13. The computer apparatus of claim 10, wherein the bidding related to participation in the potential sporting event is bidding related to competing in said potential sporting event.

14. The computer apparatus of claim 10, wherein the bidding related to participation in the potential sporting event is bidding related to advertising said potential sporting event.

15. The computer apparatus of claim 10, wherein the bidding related to participation in the potential sporting event is bidding related to sponsorship of said potential sporting event.

16. The computer apparatus of claim 10, wherein information concerning the bid of a first bidding party is made available to other bidding parties.

17. The computer apparatus of claim 10, wherein information concerning the bid of a first bidding party is not made available to other bidding parties.

18. The computer apparatus of claim 10, wherein bidding is performed electronically over a global computer network.

19. A system for organizing and coordinating a competitive event comprising the steps of:
a) receiving information from at least one user regarding said user's willingness to consider participation in a potential competitive event;
b) organizing said information received from said at least one user into an electronically searchable format;
c) providing access to said information organized into the electronically searchable format to said user and third parties;
d) receiving a bid from a third party related to participation in the competitive event;
e) providing information regarding said third party's bid to at least one party authorized to accept said bid;
f) notifying said third party of an acceptance of said bid; and
g) providing access to information regarding the acceptance of said bid.

20. The system of claim 19, wherein said participation in said competitive event is selected from the group of participation activities consisting of promoting said competitive event, hosting said competitive event, competing in said competitive event, advertising in said competitive event, and sponsoring said competitive event.
